(19) United States
(12) Patent Application Publication
(10) Pub. No.: US 2025/0263595 A1
(43) Pub. Date: Aug. 21, 2025

(54) METHOD FOR PREPARING REFRIGERANT, AND REFRIGERANT

(71) Applicants: Monatec Co., Ltd., Shizuoka (JP); Kagoshima University, Kagoshima (JP)

(72) Inventors: Tooru NAKAYAMA, Shizuoka (JP); Rinkou FUKUNAGA, Kagoshima (JP); Rika NAKAYAMA, Kagoshima (JP); Kei MIZUTA, Kagoshima (JP)

(21) Appl. No.: 18/856,567

(22) PCT Filed: Apr. 12, 2023
(86) PCT No.: PCT/JP2023/014858

§ 371 Date: Oct. 11, 2024

(30) Foreign Application Priority Data
Apr. 13, 2022 (JP) 2022-066640

(51) Int. Cl. C09K 5/04; F28D 15/02

(52) U.S. Cl. CPC C09K 5/04; F28D 15/0283

(57) ABSTRACT

A method for preparing a refrigerant involves adding an additive to a refrigerant in a composition and concentration that satisfy the following conditions: in a case where a predetermined heat quantity Qᵢₙ [W] is applied to a heat diffusion board from a cooling object, the heat diffusion board has the value of a plane direction thermal conductivity kᵣ [Wm⁻¹K⁻¹] that satisfies the value of Biot number to be achieved and the value of a thickness direction thermal conductivity k_{z} [Wm⁻¹K⁻¹] that satisfies thermal resistance to be achieved, in order to suppress the temperature Tᵢₙ[K] of a heat receiver of the heat diffusion board and the in-plane temperature irregularity ΔT[K] of the heat diffusion board to be a predetermined value T_{in.C}[K] or less and a predetermined value ΔT_{c}[K] or less, respectively; and the values of the plane direction thermal conductivity kᵣ [Wm⁻¹K⁻¹] and the thickness direction thermal conductivity k_{z} [Wm⁻¹K⁻¹] are maintained within the range of values to be achieved even if the heat diffusion board is repeatedly exposed to temperatures ranging from below the freezing point to above the boiling point of water, and even if the heat diffusion board is exposed to a high temperature at 150° C. or higher.

### TECHNICAL FIELD

The present disclosure relates to a method for preparing a refrigerant and the refrigerant.

### BACKGROUND ART

Heat diffusion boards, which are used for cooling electronic devices, and the like, receive heat from a cooling object and diffuse heat internally in the plane direction, thereby reducing heat density. Among others, in a heat diffusion board such as a vapor chamber and a flat heat pipe, heat diffusion is achieved by transporting heat through a phase change of the refrigerant sealed inside (e.g., Patent Literature 1 and Patent Literature 2).

In a vapor chamber, a refrigerant that has received heat from a cooling object vaporizes into a gas in an evaporator and moves inside because of pressure difference. The gaseous refrigerant that has reached a condenser condenses back to liquid as it dissipates heat out of the system. The refrigerant that has returned to liquid moves by capillary action and/or gravity and returns to the evaporator.

The refrigerant to be used in a vapor chamber is required to function continuously as a latent heat transport medium. In order for the refrigerant to continuously function as a latent heat transport medium, sustained transport of latent heat at or higher than the heat load applied from the cooling object to the heat diffusion board should be performed.

As for the refrigerant to be used in a vapor chamber, Non Patent Literature 1 and the like report that thermal performance improves when a substance with a large latent heat of vaporization is used, and thus water having a small molecular weight and large latent heat of vaporization is suitable.

On the other hand, water increases in volume due to solidification, which deforms internal structures such as microfluidic channels that function as wicks and the outer shell structure of the vapor chamber, causing loss of functionality of the vapor chamber. Therefore, in a case where water is used as a refrigerant, an effective method to suppress vapor chamber deformation due to water solidification is to prevent crystallization of water upon solidification after addition of an additive. Examples of an additive include those containing glycols such as ethylene glycol used therein (Patent Literature 3).

### CITATION LIST

### Patent Literature

Patent Literature 1: Unexamined Japanese Patent Application Publication No. 2019-113232
Patent Literature 2: Unexamined Japanese Patent Application Publication No. 2009-236362
Patent Literature 3: Unexamined Japanese Patent Application Publication No. 2005-9752
Patent Literature 4: Japanese Patent No. 6539862

### Non Patent Literature

Non Patent Literature 1: S, C. Wong et. al, Applied Thermal Engineering, 31 (2011), 1757-1762

### SUMMARY OF INVENTION

### Technical Problem

Factors that reduce the amount of latent heat transport by a refrigerant in a vapor chamber include inhibition of the evaporation and condensation phase changes of the refrigerant and inhibition of liquid return by capillary action and/or gravity. The inhibiting factor for the phase change in which a refrigerant evaporates is a situation in which the boiling heat transfer efficiency of the refrigerant is reduced due to the coexistence of gases other than water vapor inside the vapor chamber. In particular, the use of additives with high vapor pressure as additives to be added to water used to prevent crystallization and the higher partial pressure caused by the additives reduce the boiling heat transfer efficiency of water, causing the vapor chamber to function poorly.

In a vapor chamber configured to return the refrigerant, which has become liquid, to an evaporator by capillary action, if the surface tension is lowered by the additive, the driving force for the refrigerant to return is reduced, thereby inhibiting the return of the refrigerant and causing the vapor chamber to function poorly. Furthermore, if the viscosity of the refrigerant increases due to the addition of additives, the flow resistance of the refrigerant will increase, inhibiting the return of the refrigerant and causing the vapor chamber to function poorly.

Therefore, regarding an additive to be used as an agent for suppressing crystallization due to solidification in a case where water is used as the refrigerant of a vapor chamber, it is essential for the additive to have: an effect resulting from vapor pressure generation due to the additive moving from the refrigerant to the gas phase: an effect resulting from surface tension decrease due to the additive; and an effect resulting from viscosity increase due to the additive that is suppressed within a range such that the thermal performance required for the vapor chamber as a heat diffusion board can be maintained.

The thermal performance required for a vapor chamber to have as the heat diffusion board is an effect of temperature smoothing by thermal diffusion and an effect of suppressing the temperature rise of a cooling object.

The degree of the temperature smoothing effect due to thermal diffusion that is necessary for the vapor chamber to achieve thermal performance required as the heat diffusion board can be determined by the method described in Patent Literature 4.

As described in Patent Literature 4, the degree of the temperature smoothing effect of the vapor chamber depends on Biot number Bi, defined by the following equation.

Bi=hL/k

Where h [Wm⁻²K⁻¹] is the overall heat transfer coefficient when heat is dissipated from the vapor chamber to outside the system, L [m] is the representative length related to the size of a cooling object, and k [Wm⁻¹K⁻¹] is the thermal conductivity of the vapor chamber. The overall heat transfer coefficient is calculated from the total heat quantity from the circuit and the set value of the average temperature of the heat radiation face of the vapor chamber.

A large value of Biot number results in a relatively low temperature smoothing effect, leading to a large temperature irregularity (difference between the highest and lowest temperatures within the substrate surface) within the substrate surface. In contrast, a small Biot number results in a relatively high effect of temperature smoothing, leading to a small temperature irregularity of the substrate.

Since the value of the overall heat transfer coefficient is determined by heat quantity applied to the vapor chamber and a target temperature as the average vapor chamber surface temperature, there is no flexibility in reducing the value of Biot number by decreasing the value of the overall heat transfer coefficient. Similarly, the representative length related to the size of a cooling object is also a value that is determined when a target cooling object is determined, so there is no flexibility in reducing the Biot number by decreasing this value.

Therefore, in order to achieve the degree of temperature smoothing effect due to thermal diffusion required to achieve thermal performance, among the temperature smoothing effect required for a vapor chamber to have as the heat diffusion board, the only possible means for reducing Biot number is to increase the thermal conductivity of the vapor chamber.

The present disclosure is created in consideration of the above matters, and its objective is to provide a method for preparing a refrigerant capable of increasing the thermal conductivity of a heat diffusion board, and the refrigerant.

### Solution to Problem

A method for preparing a refrigerant according to a first aspect of the present disclosure is a method for preparing a refrigerant containing water as a main component and sealed in a heat diffusion board, wherein
in a case where a predetermined heat quantity Qᵢₙ [W] is applied to the heat diffusion board from a cooling object,
the heat diffusion board has the value of a plane direction thermal conductivity kᵣ [Wm⁻¹K⁻¹] that satisfies the value of Biot number to be achieved and the value of a thickness direction thermal conductivity k_{z} [Wm⁻¹K⁻¹] that satisfies thermal resistance to be achieved, in order to suppress the temperature Tᵢₙ[K] of a heat receiver of the heat diffusion board and the in-plane temperature irregularity ΔT[K] of the heat diffusion board to a predetermined value T_{in.C}[K] or less and a predetermined value ΔT_{c}[K] or less, respectively, and
an additive is added to the refrigerant in a composition and concentration that satisfy conditions under which the values of the plane direction thermal conductivity kᵣ [Wm⁻¹K⁻¹] and the thickness direction thermal conductivity k_{z} [Wm⁻¹K⁻¹] are maintained within the range of values to be achieved even if the heat diffusion board is repeatedly exposed to temperatures ranging from below the freezing point to above the boiling point of water, and even if the heat diffusion board is exposed to a high temperature at 150° C. or higher.

It is also preferable to add the additive that can suppress crystallization when water solidifies, thereby suppressing deformation of the structure of the heat diffusion board, suppress the decrease in surface tension that is the driving force for the condensed refrigerant to return, to be in a predetermined range, and suppress the increase in liquid viscosity that is the resistance for the condensed refrigerant to return, to be in a predetermined range.

The refrigerant according to a second aspect of the present disclosure is prepared by the method for preparing a refrigerant according to the first aspect of the present disclosure.

The refrigerant preferably contains water as a main component and 0.5 to 20.0% by weight of 1,4-dioxane.

Further, the refrigerant preferably contains water as a main component and 0.5 to 30.0% by weight of diethylene glycol dimethyl ether.

### Advantageous Effects of Invention

According to the present disclosure, a method for preparing a refrigerant capable of increasing the thermal conductivity of a heat diffusion board and the refrigerant can be provided.

### BRIEF DESCRIPTION OF DRAWINGS

FIG. 1 illustrates a plan view (FIG. 1A) and a cross-sectional view (FIG. 1B) depicting a cooling object with a heat diffusion board in place;

FIG. 2 is a graph illustrating the relationship between the concentrations of additives and the plane direction thermal conductivity kᵣ in Example 4; and

FIG. 3 is a graph illustrating the relationship between the concentrations of additives and the thickness direction thermal conductivity k_{z} in Example 4.

### DESCRIPTION OF EMBODIMENTS

The method for preparing a refrigerant containing water as a main component and sealed in a heat diffusion board and the refrigerant according to the present embodiment are described.

The heat diffusion board, in which the refrigerant is sealed in, is installed in a cooling object, such as a vapor chamber or a flat heat pipe, to dissipate heat received from the cooling object. Examples of the heat diffusion board include a structure with an internal space composed of a vapor diffusion passage through which a vaporized refrigerant diffuses and a capillary channel through which a condensed refrigerant is sent by capillary action, such as the structures disclosed in the Japanese Patent No. 5178274 and the Unexamined Japanese Patent Application Publication No. 2019-113232.

Examples of the cooling object include IC (semiconductor integrated devices), LSI (large-scale integrated circuit devices), Central Processing Units (CPU), LED elements, power devices, and other devices that generate heat.

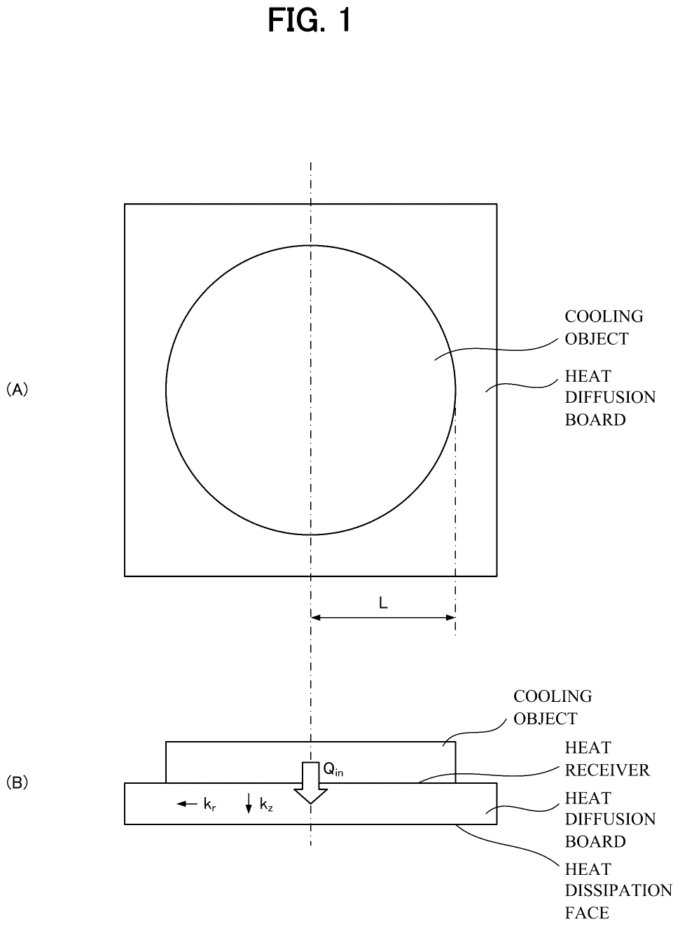

First, the thermal relationship between the heat diffusion board and the cooling object is described taking as an example the situation depicted in FIG. 1 where the heat diffusion board in the shape of a square is installed in a cooling object in the shape of a circle.

Equation 1 is derived from Newton's law of cooling.

$$[ Equation 1 ]$$

$${Q}_{in} = {A}_{in} {U}_{in} ( {T}_{in} - {T}_{a} ) \qquad Equation 1$$

Where Qᵢₙ [W] is incoming heat quantity entering from the cooling object into the heat diffusion board, Uᵢₙ [Wm⁻²K⁻¹] is the overall heat transfer coefficient in terms of the heat receiver area of the heat diffusion board, Aᵢₙ [m²] is the heat receiver area, Tᵢₙ[K] is the heat receiver temperature, and Tₐ[K] is ambient temperature.

If the upper limit allowed as the heat receiver temperature is T_{in.c} [K], the relationship to be satisfied by the overall heat transfer coefficient Uᵢₙ [Wm⁻²K⁻¹] in terms of the heat receiver area is expressed by Equation 2.

$$[ Equation 2 ]$$

$${U}_{in} > \frac{{Q}_{in}}{{A}_{in} ( {T}_{in , c} - {T}_{a} )} \qquad Equation 2$$

Here, using the representative length L [m] representing the size of the cooling object, the length [m] of a piece of the heat diffusion board, and the thickness [m] of the heat diffusion board, the surface temperature distribution on the heat radiation face side of the heat diffusion board is obtained, from which the temperature irregularity ΔT [K] (=difference between the in-plane maximum and minimum temperatures) and the heat radiation face average temperature <T_{cond.sf}> [K] at the heat radiation face of the heat diffusion board are obtained, as depicted in FIG. 20 described in Applied Thermal Engineering, 146 (2019), 843-853.

Note that from Applied Thermal Engineering, 146 (2019), 843-853, the temperature distribution on the heat radiation face side of the heat diffusion board is expressed as the function of Biot number Biᵣ by Equation 3.

$$[ Equation 3 ]$$

$${Bi}_{r} = \frac{hL}{{k}_{r}} \qquad Equation 3$$

Where h [Wm⁻²K⁻¹] is the overall heat transfer coefficient in terms of the heat radiation face of the heat diffusion board and kᵣ [Wm⁻¹K⁻¹] is the plane direction thermal conductivity of the heat diffusion board. For the overall heat transfer coefficient h [Wm⁻²K⁻¹] in terms of the heat radiation face, the condition in Equation 4 is satisfied for the incoming heat quantity Qᵢₙ [W] from the cooling object to the heat diffusion board.

$$[ Equation 4 ]$$

$$h = \frac{{Q}_{in}}{{A}_{out} ( 〈 {T}_{cond . sf} 〉 - {T}_{a} )} \qquad Equation 4$$

Where Aₒᵤₜ [m²] is the area of the heat radiation face of the heat diffusion board.

From the definition of the overall heat transfer coefficient h in Equation 4, there is a relationship expressed by Equation 5 among the overall heat transfer coefficient Un in terms of the heat receiver area, the heat receiver temperature Tᵢₙ, and the heat radiation face average temperature <T_{cond.sf}>.

$$[ Equation 5 ]$$

$$\frac{1}{{U}_{in} {A}_{in}} = {R}_{th . smp} + {R}_{th . conv} = \frac{1}{{k}_{z} S} + \frac{1}{{hA}_{out}} \qquad Equation 5$$

Where k_{z} [Wm⁻¹K⁻¹] is the thickness direction thermal conductivity of the heat diffusion board and S [m] is the shape factor of the heat diffusion board described in Applied Thermal Engineering, 146 (2019) 843-853. The shape factor is defined as a function of the size of the cooling object, the thickness of the heat diffusion board and the thermal conductivity in Applied Thermal Engineering, 146 (2019), 843-853.

Then, from Equations 1, 4, and 5, the relationship expressed by Equation 6 is obtained.

$$[ Equation 6 ]$$

$$\frac{{T}_{in} - {T}_{a}}{{Q}_{in}} = \frac{1}{{k}_{z} S} + \frac{〈 {T}_{cond . sf} 〉 - {T}_{a}}{{Q}_{in}} \\ {k}_{z} = \frac{{Q}_{in}}{S ( {T}_{in} - 〈 {T}_{cond . sf} 〉 )} \qquad Equation 6$$

From Equations 2 and 6, the condition that k_{z} must satisfy when the upper limit allowed for the heat receiver temperature is T_{in.c} is given by Equation 7.

$$[ Equation 7 ]$$

$${k}_{z} > \frac{{Q}_{in}}{S ( {T}_{in . c} - 〈 {T}_{cond . sf} 〉 )} \qquad Equation 7$$

On the other hand, the in-plane temperature irregularity ΔT [K] of the heat diffusion board is given by Equation 8 described in Applied Thermal Engineering, 146 (2019), 843-853.

$$[ Equation 8 ]$$

$$Δ T = ΔΘ {T}_{R}^{*} = \{ {Θ}^{I} ( 0 ) - {Θ}^{II} ( {r}_{e}^{*} ) \} ( {T}_{R} - {T}_{a} - \frac{{q}_{in}}{h} ) \qquad Equation 8$$

Where Θ[-] is the dimensionless temperature, and in particular Θ^{I} (0) is the dimensionless temperature at the center of the cooling object, Θ^{II} (rₑ*) is the dimensionless temperature at the edge of the heat diffusion board, T_{R}[K] is the temperature of the heat diffusion board at the edge of the cooling object, and qᵢₙ [Wm⁻²] is the heat flux upon heat input from the cooling object.

At this time, the temperature of the heat diffusion board at the edge of the heat diffusion board is a function of Biot number. ΔΘ increases as the Biot number increases and ΔΘ decreases as the Biot number decreases. Thus, given the tolerance ΔT_{c}[K] of the in-plane temperature irregularity, the plane direction thermal conductivity kᵣ [Wm⁻¹K⁻¹] and the thickness direction thermal conductivity k_{z} [Wm⁻¹K⁻¹] values that satisfy Equation 9 can be determined by trial and error.

$$[ Equation 9 ]$$

$$Δ {T}_{c} > \{ {Θ}^{I} ( 0 ) - {Θ}^{II} ( {r}_{e}^{*} ) \} ( {T}_{R} - {T}_{a} - \frac{{q}_{in}}{h} ) \qquad Equation 9$$

Based on the thermal relationship between the heat diffusion board and the cooling object described above, it is possible to determine by the following procedure the composition and the concentration of an appropriate additive to be added to a refrigerant mainly composed of water, in order to provide the refrigerant to be sealed in the heat diffusion board satisfying the preconditions.

### (Preconditions)

First, as preconditions, respective tolerances T_{in.c} [K] and ΔT_{c} [K] for the heat receiver temperature and the in-plane temperature irregularity ΔT [K] of the heat diffusion board are provided.

### (Step 1)

From Equation 2, the value to be satisfied for the overall heat transfer coefficient Uᵢₙ in terms of the heat receiving area is determined.

### (Step 2)

The range of values of kᵣ and k_{z} that simultaneously satisfy Equations 7 and 9 is determined as conditions to be satisfied for the plane direction thermal conductivity kᵣ and the thickness direction thermal conductivity k_{z}.

### (Step 3)

For an additive to be added to water that is the main component of the refrigerant, the composition and the concentration of chemical species that satisfy conditions (A) under which the values of kᵣ and k_{z} are maintained within the determined range, even if the heat diffusion board is repeatedly exposed to temperatures ranging from below the freezing point to above the boiling point of water, and conditions (B) under which the values of kᵣ and k_{z} are maintained within the determined range, even if the heat diffusion board is exposed to a high temperature at 150° C. or higher. The refrigerant can then be prepared by adding the additive to water.

In addition, to satisfy the above conditions (A) and (B), the composition and the concentration of chemical species are determined in such a manner that they can (C) suppress the deformation of the structure of the heat diffusion board by suppressing crystallization upon solidification, (D) suppress the decrease in surface tension that is the driving force for the return of the condensed refrigerant, to be in a predetermined range, and (E) suppress the increase in liquid viscosity that is the resistance for the condensed refrigerant to return, to be in a predetermined range.

Specific examples of an additive determined according to the above steps are 1,4-dioxane and diethylene glycol dimethyl ether. In a case where the additive is 1,4-dioxane, the content is preferably from 0.5 to 20.0% by weight, and more preferably from 0.5 to 6.0% by weight. When the additive is diethylene glycol dimethyl ether, the content is preferably from 0.5 to 30.0% by weight, and more preferably from 0.5 to 5.0% by weight. The refrigerant may be a refrigerant consisting of water and these additives, or it may be a refrigerant containing other additives as long as they do not inhibit.

### EXAMPLES

### Example 1

A commercially available “□50 mm” (50 mm×50 mm, thickness 2.2 mm) heat diffusion board (FGHP (registered trademark, Shikoku Instrumentation Co., Ltd.)) containing no sealed-in refrigerant was prepared. For the heat diffusion board, the following preconditions and setup conditions were set, so as to determine the plane direction thermal conductivity kᵣ and the thickness direction thermal conductivity k_{z} to be satisfied by the heat diffusion board. Test specimen size, test conditions, preconditions, setup conditions, temperature smoothing effect, conditions for the plane direction thermal conductivity kᵣ to be satisfied, and conditions for the thickness direction thermal conductivity k_{z} to be satisfied are as described below.

### <Test Specimen Size and Test Conditions>

Heat diffusion board size: 50 mm square
Heat diffusion board thickness: 2.2 mm
Heat source size (cooling object): 10 mm square

### <Preconditions, Setup Conditions>

Incoming heat quantity Qᵢₙ: 80 W
Heat receiver temperature T_{in.C}: 343K
Temperature irregularity tolerance ΔT_{c}: 2.0 K
Temperature irregularity ΔT: 2.0K
Ambient temperature: 298K

### <Temperature Smoothing Effect>

Biot number Biᵣ: 1.090
Overall heat transfer coefficient h: 732.8 Wm⁻²K⁻¹
   <Conditions for Plane Direction Thermal Conductivity kᵣ and Thickness Direction Thermal Conductivity k_{z} to be Satisfied>
Plane direction thermal conductivity kᵣ>4,245Wm⁻¹K⁻¹
Thickness direction thermal conductivity k_{z}>395Wm⁻¹K⁻¹

Refrigerants prepared by adding additives (various chemical species and concentrations) to water were each sealed in the heat diffusion board, and then the following cycle test and the following high temperature shelf test were conducted.

The heat diffusion board immediately after fabrication, the same after the cycle test, and the same after the high temperature shelf test were subjected to measurement by the apparatus described in FIG. 4 in Applied Thermal Engineering, 104 (2016), 461-471, as cited in Applied Thermal Engineering, 146 (2019), 843-853, thereby examining whether or not the plane direction thermal conductivity kᵣ and the thickness direction thermal conductivity k_{z} determined by the method described in Applied Thermal Engineering, 146 (2019), 843-853 satisfy the conditions determined above.

### <Cycle Test>

The cycle test was conducted for 1,000 cycles with the following temperature conditions as one cycle.
Temperature conditions: −20° ° C. for 30 minutes→25° C. for 10 minutes→100° C. for 30 minutes→25° C. for 10 minutes

### <High Temperature Shelf Test>

The high temperature shelf test was conducted by leaving a product at a temperature condition of 150° C. for 1,000 hours.

The results are shown in Table 1. Those that satisfied the conditions of the plane direction thermal conductivity kᵣ>4.245Wm⁻¹K⁻¹ and the thickness direction thermal conductivity k_{z}>395Wm⁻¹K⁻¹ are marked as “OK”, and those that did not satisfy the conditions are marked as “NG”. In the table. DEGDME is diethylene glycol dimethyl ether.

TABLE 1

| | | | IMMEDIATELY AFTER | | AFTER CYCLE | | AFTER HIGH TEMPERATURE | |
|---|---|---|---|---|---|---|---|---|
| | | ADDITION | PRODUCTION | | TEST | | SHELF TEST | |
| | | AMOUNT | kᵣ | k_{z} | kᵣ | k_{z} | kᵣ | k_{z} |
| No. | ADDITIVE | (WT %) | [W m⁻¹ K⁻¹] | [W m⁻¹ K⁻¹] | [W m⁻¹ K⁻¹] | [W m⁻¹ K⁻¹] | [W m⁻¹ K⁻¹] | [W m⁻¹ K⁻¹] |
| 1 | NO ADDITIVE | — | OK | OK | NG | NG | OK | OK |
| 2 | 1,4-DIOXANE | 0.1 | OK | OK | NG | NG | OK | OK |
| 3 | 1,4-DIOXANE | 0.5 | OK | OK | OK | OK | OK | OK |
| 4 | 1,4-DIOXANE | 1.0 | OK | OK | OK | OK | OK | OK |
| 5 | 1,4-DIOXANE | 3.0 | OK | OK | OK | OK | OK | OK |
| 6 | DEGDME | 0.5 | OK | OK | OK | OK | OK | OK |
| 7 | ETHANOL | 0.5 | OK | OK | OK | OK | NG | NG |
| 8 | ACETONE | 0.5 | OK | OK | NG | NG | OK | OK |
| 9 | METHYL ETHYL KETONE | 0.3 | NG | NG | NG | NG | NG | NG |
| 10 | METHYL ISOBUTYL KETONE | 0.3 | NG | NG | NG | NG | NG | NG |
| 11 | DIGLYME | 0.5 | NG | NG | NG | NG | NG | NG |
| 12 | TRIGLYME | 0.5 | NG | NG | NG | NG | NG | NG |
| 13 | TETRAGLYME | 0.5 | NG | NG | NG | NG | NG | NG |
| 14 | SODIUM SULFATE | 0.3 | OK | OK | NG | NG | NG | NG |
| 15 | POTASSIUM SULFATE | 0.3 | OK | OK | OK | OK | NG | NG |
| 16 | SUCROSE | 0.3 | NG | NG | NG | NG | NG | NG |
| 17 | N,N-DIMETHYLFORMAMIDE | 0.3 | NG | NG | NG | NG | NG | NG |
| 18 | N-METHYL-2-PYRROLIDONE | 0.3 | NG | NG | NG | NG | NG | NG |
| 19 | ACETONITRILE | 0.5 | NG | NG | NG | NG | NG | NG |
| 20 | ISOPROPANOL | 0.3 | NG | NG | NG | NG | NG | NG |
| 21 | 1-METHOXY-2-PROPANOL | 0.3 | NG | NG | NG | NG | NG | NG |
| 22 | METHYL CARBITOL | 0.3 | NG | NG | NG | NG | NG | NG |
| 23 | 2-METHOXYETHANOL | 0.3 | NG | NG | NG | NG | NG | NG |
| 24 | ETHYLENE GLYCOL | 0.3 | NG | NG | NG | NG | NG | NG |
| 25 | PROPYLENE GLYCOL | 0.3 | NG | NG | NG | NG | NG | NG |

### Example 2

A commercially available “140 mm” (140 mm×140 mm, thickness 2.2 mm) heat diffusion board (FGHP (registered trademark, Shikoku Instrumentation Co., Ltd.,)) containing no sealed-in refrigerant was prepared. For the heat diffusion board, the following preconditions and setup conditions were set, so as to determine the plane direction thermal conductivity k and the thickness direction thermal conductivity k_{z} to be satisfied by the heat diffusion board. Test specimen size, test conditions, preconditions, setup conditions, temperature smoothing effect, conditions for the plane direction thermal conductivity kᵣ to be satisfied, and, conditions for the thickness direction thermal conductivity k_{z} are as described below.

### <Test Specimen Size and Test Conditions>

Heat diffusion board size: 140 mm square
Heat diffusion board thickness: 2.2 mm
Heat source size (cooling object): Φ40 mm

### <Preconditions, Setup Conditions>

Incoming heat quantity Qᵢₙ: 290 W
Heat receiver temperature tolerance T_{in.C}: 343 K
Temperature irregularity tolerance ΔT_{c}: 2.0 K
Temperature irregularity ΔT: 3.0K
Ambient temperature: 298K

### <Temperature Smoothing Effect>

Biot number Biᵣ: 1.223
Overall heat transfer coefficient h: 307.0 Wm⁻²K⁻¹
   <Conditions for the Plane Direction Thermal Conductivity kᵣ and the Thickness Direction Thermal Conductivity k_{z} to be Satisfied>
Plane direction thermal conductivity kᵣ>6,795Wm⁻¹K⁻¹
Thickness direction thermal conductivity k_{z}>395Wm⁻¹K⁻¹

Refrigerants prepared by adding additives (various chemical species and concentrations) to water were each sealed in the heat diffusion board. The cycle test and the following high temperature shelf test were conducted using the same method as in Example 1. The heat diffusion board of immediately after fabrication, after the cycle test, and after the high temperature shelf test was examined whether or not the plane direction thermal conductivity kᵣ and the thickness direction thermal conductivity k_{z} determined by the same method as in Example 1 satisfy the conditions determined above.

The results are shown in Table 2. Those that satisfied the conditions of the plane direction thermal conductivity kᵣ>6,795Wm⁻¹K⁻¹ and the thickness direction thermal conductivity k_{z}>395Wm⁻¹K⁻¹ are marked as “OK”, and those that did not satisfy the conditions are marked as “NG”. In the table, DEGDME is diethylene glycol dimethyl ether.

TABLE 2

| | | | IMMEDIATELY AFTER | | AFTER CYCLE | | AFTER HIGH TEMPERATURE | |
|---|---|---|---|---|---|---|---|---|
| | | ADDITION | PRODUCTION | | TEST | | SHELF TEST | |
| | | AMOUNT | kᵣ | k_{z} | kᵣ | k_{z} | kᵣ | k_{z} |
| No. | ADDITIVE | (WT %) | [W m⁻¹ K⁻¹] | [W m⁻¹ K⁻¹] | [W m⁻¹ K⁻¹] | [W m⁻¹ K⁻¹] | [W m⁻¹ K⁻¹] | [W m⁻¹ K⁻¹] |
| 1 | NO ADDITIVE | — | OK | OK | NG | NG | OK | OK |
| 2 | DEGDME | 1.0 | OK | OK | OK | OK | OK | OK |
| 3 | DEGDME | 3.0 | OK | OK | OK | OK | OK | OK |
| 4 | DEGDME | 5.0 | OK | OK | OK | OK | OK | OK |

### Example 3

A commercially available “˜ 120 mm” (φ120 mm, thickness 2.2 mm) heat diffusion board (FGHP (registered trademark, Shikoku Instrumentation Co., Ltd) containing no sealed-in refrigerant was prepared. For the heat diffusion board, the following preconditions and setup conditions were set, so as to determine the plane direction thermal conductivity kᵣ and the thickness direction thermal conductivity k_{z} to be satisfied by the heat diffusion board. Test specimen size, test conditions, preconditions, setup conditions, temperature smoothing effect, conditions for the plane direction thermal conductivity kᵣ, and conditions for the thickness direction thermal conductivity k_{z} to be satisfied are as described below.

### <Test Specimen Size and Test Conditions>

Heat diffusion board size: 120 mm
Heat diffusion board thickness: 2.2 mm
Heat source size (cooling object): 20 mm square

### <Preconditions, Setup Conditions>

Incoming heat quantity Qᵢₙ: 200 W
Heat receiver temperature tolerance T_{in.C}: 343 K
Temperature irregularity tolerance ΔT_{c}: 2.0 K
Temperature irregularity ΔT: 3.0K
Ambient temperature: 298K

### <Temperature Smoothing Effect>

Biot number Biᵣ: 1.176
Overall heat transfer coefficient h: 291.4Wm⁻²K⁻¹
   <Conditions for Plane Direction Thermal Conductivity kᵣ and Thickness Direction Thermal Conductivity k_{z} to be Satisfied>
Plane direction thermal conductivity kᵣ>6,670Wm⁻¹K⁻¹
Thickness direction thermal conductivity k_{z}>395Wm⁻¹K⁻¹

Refrigerants prepared by adding additives (various chemical species and concentrations) to water were each sealed in the heat diffusion board, and then the cycle test and the following high temperature shelf test were conducted using the same method as in Example 1. Then, the heat diffusion board immediately after fabrication, after the 5 cycle test, and after the high temperature shelf test were examined whether or not the plane direction thermal conductivity kᵣ and the thickness direction thermal conductivity k_{z}, determined by the same method as in Example 1 satisfy the conditions determined above.

The results are shown in Table 3. Those that satisfied the conditions of the plane direction thermal conductivity kᵣ>6,670Wm⁻¹K⁻¹ and the thickness direction thermal conductivity k_{z}>395Wm⁻¹K⁻¹ are marked as “OK”, and those that did not satisfy the conditions are marked as “NG”.

TABLE 3

| | | | IMMEDIATELY AFTER | | AFTER CYCLE | | AFTER HIGH TEMPERATURE | |
|---|---|---|---|---|---|---|---|---|
| | | ADDITION | PRODUCTION | | TEST | | SHELF TEST | |
| | | AMOUNT | kᵣ | k_{z} | kᵣ | k_{z} | kᵣ | k_{z} |
| No. | ADDITIVE | (WT %) | [W m⁻¹ K⁻¹] | [W m⁻¹ K⁻¹] | [W m⁻¹ K⁻¹] | [W m⁻¹ K⁻¹] | [W m⁻¹ K⁻¹] | [W m⁻¹ K⁻¹] |
| 1 | NO ADDITIVE | — | OK | OK | NG | NG | OK | OK |
| 1 | 1,4-DIOXANE | 0.1 | OK | OK | OK | OK | OK | OK |
| 2 | 1,4-DIOXANE | 2.0 | OK | OK | OK | OK | OK | OK |
| 3 | 1,4-DIOXANE | 4.0 | OK | OK | OK | OK | OK | OK |
| 4 | 1,4-DIOXANE | 6.0 | OK | OK | OK | OK | OK | OK |

### Example 4

A commercially available ∘40 mm (Φ40 mm, thickness 2.0 mm) heat diffusion board (FGHP (registered trademark, Shikoku Instrumentation Co., Ltd) containing no sealed-in refrigerant was prepared. A refrigerant prepared by adding a predetermined concentration of 1,4-dioxane or diethylene glycol dimethyl ether (hereinafter referred to as DEGDME) as an additive to water was sealed in the heat diffusion board, for conducting a cycle test. The cycle test was conducted for 200 cycles, each cycle of which is the same as that of the cycle test described in Example 1. After the cycle test, the plane direction thermal conductivity kᵣ and the thickness direction thermal conductivity k_{z} of the heat diffusion board were measured by the apparatus described in FIG. 4 in Applied Thermal Engineering, 104 (2016), 461-471, cited in Applied Thermal Engineering, 146 (2019), 843-853 and determined by the method described in Applied Thermal Engineering, 146 (2019), 843-853, so as to examine if kᵣ and k_{z} satisfy the conditions determined above. Test specimen size and test conditions are as described below.

### <Test Specimen Size and Test Conditions>

Heat diffusion board size: Ø40 mm
Heat diffusion board thickness: 2.0 mm
Heat source size (cooling object): 5 mm square
Incoming heat quantity Qᵢₙ: 14.8 to 15.1 W (Evaluation was conducted at a constant current value of 0.7 A) (The voltage value varies with heater temperature, so the incoming heat quantity varies around 15 W.)

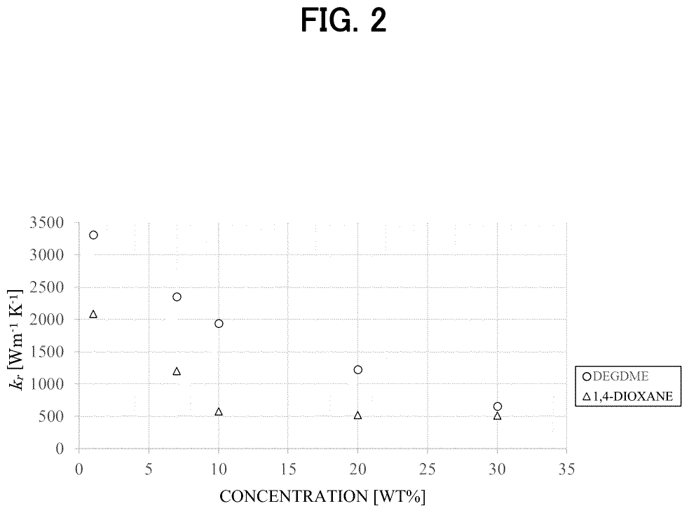

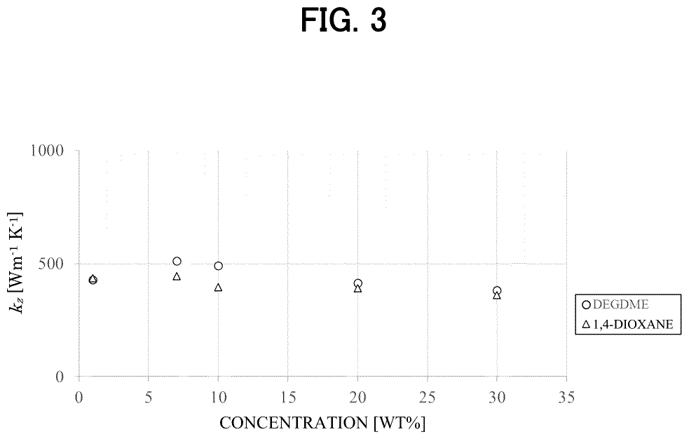

Changes in the plane direction thermal conductivity kᵣ and the thickness direction thermal conductivity k_{z} due to varying concentrations of 1,4-dioxane and di-DEGDME are depicted in FIG. 2 and FIG. 3, respectively. As depicted in FIG. 2 and FIG. 3, the values of the plane direction thermal conductivity kᵣ and the thickness direction thermal conductivity k_{z} vary with the concentration of an additive(s). Considering that the values of the plane direction thermal conductivity kᵣ and the thickness direction thermal conductivity k_{z} of a copper plate of the same size as the heat diffusion board used are both less than 500Wm⁻¹K⁻¹, it can be said that if the amount of 1,4-dioxane to be added as an additive is 20% by weight or less, or, the amount of DEGDME to be added as an additive is 60% by weight or less, the resulting heat diffusion board can be used as the one capable of exhibiting performance better than that of the copper plate.

The shape factor S [m] can be calculated from the values of kᵣ and k_{z} by the method described in Applied Thermal Engineering, 146 (2019), 843-853. Using the shape factor S, the value of any overall heat transfer coefficient; that is, the overall heat transfer coefficient Uᵢₙ can be calculated in terms of the heat receiver area by the method described in Equation 5.

As described above, through calculation of the values of thermal conductivity kᵣ and k_{z} of the heat diffusion board fabricated by adding any type of additive at any concentration, it is possible to determine whether the heat diffusion board has thermal performance satisfying: Equation 2 relating to T_{in.c} the upper limit permissible as the heat receiver temperature; and moreover Equation 9 relating to ΔT_{c} [K] tolerance of in-plane temperature irregularity of the heat diffusion board, respectively.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-66640 filed on Apr. 13, 2022, the entire disclosure of which is incorporated by reference herein.

1. A method for preparing a refrigerant containing water as a main component and sealed in a heat diffusion board, wherein
in a case where a predetermined heat quantity Qᵢₙ[W] is applied to the heat diffusion board from a cooling object,
the heat diffusion board has the value of a plane direction thermal conductivity k, [Wm⁻¹K⁻¹] that satisfies the value of Biot number to be achieved and the value of a thickness direction thermal conductivity k_{z} [Wm⁻¹K⁻¹] that satisfies thermal resistance to be achieved, in order to suppress the temperature Tᵢₙ[K] of a heat receiver of the heat diffusion board and the in-plane temperature irregularity ΔT[K] of the heat diffusion board to be a predetermined value T_{in.C}[K] or less and a predetermined value ΔT_{c}[K] or less, respectively, and
an additive is added to the refrigerant in a composition and concentration that satisfy conditions under which the values of the plane direction thermal conductivity kᵣ [Wm⁻¹K⁻¹] and the thickness direction thermal conductivity k_{z} [Wm⁻¹K⁻¹] are maintained within the range of values to be achieved even if the heat diffusion board is repeatedly exposed to temperatures ranging from below a freezing point to above a boiling point of water, and even if the heat diffusion board is exposed to a high temperature at 150° C. or higher.

2. The method for preparing a refrigerant according to claim 1, comprising adding the additive that can suppress crystallization when water solidifies, thereby suppressing deformation of the structure of the heat diffusion board, suppress the decrease in surface tension that is the driving force for the condensed refrigerant to return, to be in a predetermined range, and suppress the increase in liquid viscosity that is the resistance for the condensed refrigerant to return, to be in a predetermined range.

3. A refrigerant prepared by the method for preparing a refrigerant according to claim 1.

4. The refrigerant according to claim 3, comprising water as a main component and 0.5 to 20.0% by weight of 1,4-dioxane.

5. The refrigerant according to claim 3, comprising water as a main component and 0.5 to 30.0% by weight of diethylene glycol dimethyl ether.
